(19) United States
(12) Patent Application Publication
(10) Pub. No.: US 2009/0256685 A1
(43) Pub. Date: Oct. 15, 2009

(54) DATA STORAGE METHOD AND QUERY PROCESSING METHOD FOR SUPPLY CHAIN MANAGEMENT USING RFID, AND SUPPLY CHAIN DATA MANAGEMENT SYSTEM USING RFID

(75) Inventors: Chin-Wan Chung, Daejeon (KR); Chun-Hee Lee, Daejeon (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: KOREA ADVANCED INSTITUTE OF SCIENCE AND TECHNOLOGY, Daejeon (KR)

(21) Appl. No.: 12/200,078

(22) Filed: Aug. 28, 2008

(30) Foreign Application Priority Data
Apr. 11, 2008 (KR) 1020080033481

(51) Int. Cl. H04Q 5/22

(52) U.S. Cl. 340/10.51

(57) ABSTRACT

Provided are a method which stores data using a path encoding scheme and a region numbering scheme for supply chain management using RFID, a method which processes queries about data stored by the data storage method, and a data management system which manages data for the management of the supply chain using RFID by the data storage method and the query processing method. A massive amount of RFID data generated in supply chain management using the RFID can effectively be stored, and information of the movement path of any product can be obtained from the stored data easily and quickly.

### CROSS-REFERENCE TO RELATED APPLICATIONS

This application claims the priority of Korean Patent Application No. 2008-33481 filed on Apr. 11, 2008, in the Korean Intellectual Property Office, the disclosure of which is incorporated herein by reference.

### BACKGROUND OF THE INVENTION

1. Field of the Invention

The present invention relates to a data storage method and a query processing method for supply chain management using radio frequency identification (RFID), and supply chain data management system using RFID, and more particularly, to a method which stores data using a path encoding scheme and a region numbering scheme for supply chain management using RFID, a method which processes queries about data stored by the data storage method, and a data management system which manages data by the data storage method and the query processing method for supply chain management using RFID.

2. Description of the Related Art

As the size of a radio frequency identification (RFID) tag becomes smaller and the manufacturing cost of the tag reduces, an RFID technology is widely used in various fields. Specifically, in recent years, the RFID technology is adopted and used in a commercial field such as supply chain management. In this way, in the case where the RFID technology is used for supply chain management, since the movement information of any product can easily be obtained, the RFID technology is expected to renovate the supply chain management. However, since an amount of RFID data in the supply chain management using the RFID is numerous, much time is taken to extract desired information from the RFID data.

RFID-Cuboid is a new warehouse model proposed to support compression for the RFID data and effective path-based aggregate, and represents a plurality of RFID data having the identical location and time information as one stay record. Since many products are grouped and moved at once in a supply chain management environment, an amount of data can be reduced in the case where the RFID data are represented as the stay record, thus making it easy to extract the aggregate of data. However, in the case where products are moved individually without being grouped or a query including much movement information for the products is performed, the RFID-Cuboid is inefficient.

### SUMMARY OF THE INVENTION

An aspect of the present invention provides a method which stores data using a path encoding scheme and a region numbering scheme for supply chain management using RFID, a method which processes queries about data stored by the data storage method, and a data management system which manages data by the data storage method and the query processing method for supply chain management using RFID.

According to an aspect of the present invention, there is provided a method for storing data for supply chain management using RFID, the method including: translating raw data generated in a supply chain management system using RFID into a trace record by each tag; encoding the trace record by a path encoding scheme; and storing the encoded trace record in a relational database management system.

According to another aspect of the present invention, there is provided a method for processing a query about stored data for supply chain management using RFID, the method including: translating a query input from a user into a SQL query to provide the translated query to a relational database management system; obtaining a result of the SQL query from the relational database management system; and extracting information of the query input from the user from the obtained result.

According to another aspect of the present invention, there is provided a system for managing data for a supply chain using RFID, the system including: a trace record generating unit configured to receive raw data generated in a supply chain management system using RFID as an input, translate the received raw data into a trace record by each tag, and provide the translated trace record to an encoding unit; an encoding unit configured to encode the trace record by each tag by a path encoding scheme; and a relational database management system configured to store the encoded trace record according to a pre-defined relational schema.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart illustrating a process of storing data for a supply chain management using RFID;

FIG. 2 is a tree structure of a trace record according to an embodiment of the present invention;

FIG. 3 is a time tree structure of a trace record according to an embodiment of the present invention;

FIG. 4 is a relational schema for storing data in a relational database for supply chain management using RFID according to an embodiment of the present invention;

FIG. 5 is a flowchart illustrating a process of processing queries about data stored by embodiments of the present invention; and

FIG. 6 is a block diagram of a supply chain data management system using RFID according to an embodiment of the present invention.

### DETAILED DESCRIPTION OF THE PREFERRED EMBODIMENT

Exemplary embodiments of the present invention will now be described in detail with reference to the accompanying drawings. In the following description, when the detailed description of the relevant known function or configuration is determined to unnecessarily obscure the important point of the present invention, the detailed description will be omitted.

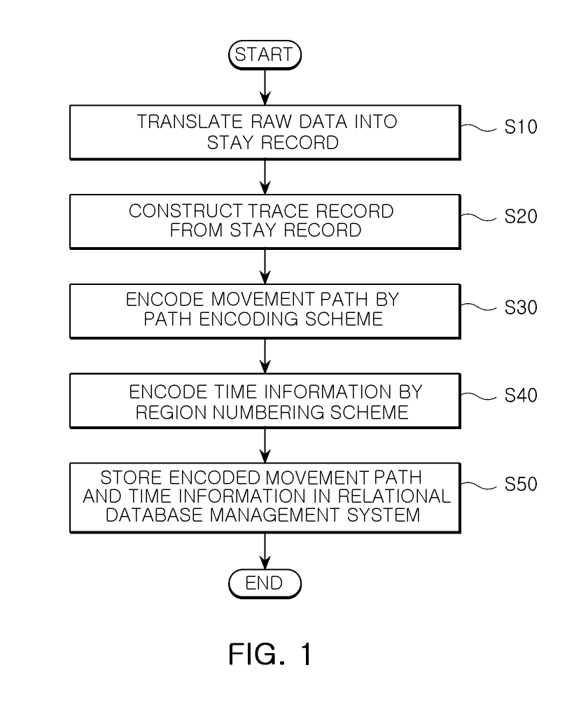

FIG. 1 is a flowchart illustrating a process of storing data for a supply chain management using RFID.

First, raw RFID data generated in a supply chain management system using RFID (hereinafter, referred to as raw data) are translated into a trace record.

The raw data are constructed with (TagID, Loc, Time). The TagID means the ID of a detected RFID tag, the Loc means location where the tag is detected, and the Time means time at which the tag is detected. Such a raw data are translated into a stay record in operation S10, and thereafter the trace record is constructed from the stay record in operation S20.

The stay record indicates the time when each product to which the RFID tag is attached stays in an arbitrary location, i.e., time which extends from the start time of the stay to the end time of the stay. The stay record is constructed with (TagID, Loc, StartTime, EndTime). In particular, the stay record according to the present invention is constructed on a tag-by-tag basis, as opposed to the related art technology.

As described above, the trace record having a form of ‘TagID: L₁[S₁, E₁]->L₂[S₂, E₂]->L₃[S₃, E₃]-> . . . ->Lₖ[Sₖ, Eₖ]’ is constructed from the stay record constructed on a tag-by-tag basis. The Lₖ denotes location in which a corresponding tag is detected, i.e., location where a product to which the tag is attached stays. The Sₖ denotes time when the tag starts to stay in the location Lₖ. The Eₖ denotes time when the tag ends to stay in the location Lₖ. Such a trace record is also constructed on a tag-by-tag basis, and information such as the movement path of a product to which a corresponding tag is attached and time when the product has stayed in any location can be obtained from the trace record.

For example, the following raw data are generated in the supply chain management system.

(tag1, A, 2), (tag4, A, 2), (tag2, A, 2), (tag3, A, 2),

(tag1, A, 3), (tag2, A, 3), (tag4, A, 3), (tag3, A, 3),

(tag3, B, 5), (tag1, B, 5), (tag2, B, 5), (tag4, B, 5),

(tag1, B, 6), (tag4, B, 6), (tag3, B, 7), (tag1, B, 7),

(tag2, B, 7), (tag4, B, 7), (tag2, C, 8), (tag1, C, 8),

(tag3, C, 8), (tag3, C, 9), (tag1, C, 9), (tag2, C, 9),

(tag4, D, 13), (tag4, D, 14), (tag4, D, 16)

In this case, the following stay records by each tag can be constructed from the raw data.

(tag1, A, 2, 3), (tag1, B, 5, 7), (tag1, C, 8, 9),

(tag2, A, 2, 3), (tag2, B, 5, 7), (tag2, C, 8, 9),

(tag3, A, 2, 3), (tag3, B, 5, 7), (tag3, C, 8, 9),

(tag4, A, 2, 3), (tag4, B, 5, 7), (tag4, D, 13, 16),

The following trace record by each tag can be constructed from the stay records by each tag.

tag1: A[2,3]->B[5,7]->C[8,9]

tag2: A[2,3]->B[5,7]->C[8,9]

tag3: A[2,3]->B[5,7]->C[8,9]

tag4: A[2,3]->B[5,7]->D[13,16]

The trace record by each tag constructed as described above is encoded by a path encoding scheme and a region numbering scheme.

More specifically, the movement path of each tag known from the trace record is encoded in an element list encoding number and an order encoding number by the path encoding scheme in operation S30. Herein, the element list encoding number is a number which encodes location information included in the movement path of each tag, and the order encoding number is a number which encodes the order of locations included in the movement path.

According to the unique factorization theorem, any number is represented as the multiplication of unique prime numbers. To encode location information included in the movement path using the theorem, a unique prime number is given on a location-by-location basis. Assumed that the movement path of any product is ‘L₁->L₂-> . . . ->Lₖ’, the element list encoding number is represented as ‘Prime(L₁)*Prime(L₂)* . . . *Prime(Lₖ)’. The Prime(Lₖ) means the unique prime number given to the location Lₖ. The element list encoding number merely informs which location is included in the movement path, but does not provide information of the movement order between each location. Accordingly, in order to encode the order of each location included in the movement path, the order encoding number is used.

According to the Chinese remainder theorem, X satisfying the following equations exists at any time.

X mod Prime(L₁)=1

X mod Prime(L₂)=2

. . .

X mod Prime(Lₖ)=k

The order encoding number is X satisfying the equations, the order of each location included in the movement path can be known using this. The order of the Lᵢ can be known by computing the X mod Prime (Lᵢ).

For example, assumed that the movement path of any product is A->B->C and respective prime numbers given to each location is Prime (A)=2, Prime (B)=3 and Prime(C)=5, the element list encoding number of the movement path is Prime(A)*Prime(B)*Prime(C)=2*3*5=30, and the order encoding number is X satisfying X mod Prime(A)=1, X mod Prime(B)=2 and X mod Prime(C)=3. In this case, X is 23. Accordingly, the movement path is encoded in (30, 23).

As described above, a tree structure is constructed by removing a duplicated path from the trace record for encoding the movement paths of various products through the path encoding scheme.

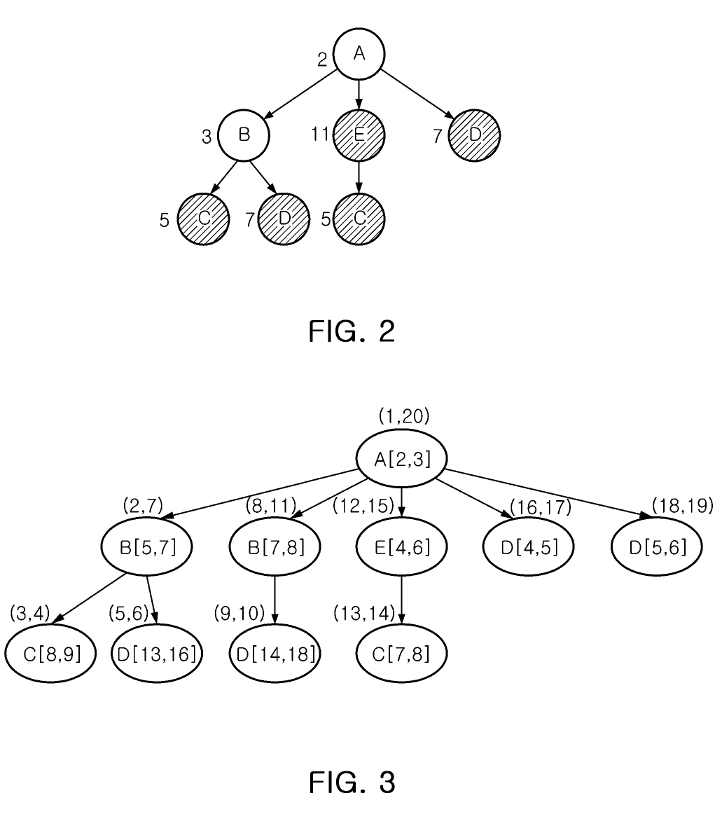

FIG. 2 is a tree structure of a trace record according to an embodiment of the present invention, and illustrates the following trace record as a tree structure.

tag1: A[2,3]->B[5,7]->C[8,9]

tag2: A[2,3]->B[5,7]->C[8,9]

tag3: A[2,3]->B[5,7]->C[8,9]

tag4: A[2,3]->B[5,7]->D[13,16]

tag5: A[2,3]->B[7,8]->D[14,18]

tag6: A[2,3]->E[4,6]->C[7,8]

tag7: A[2,3]->E[4,6]->C[7,8]

tag8: A[2,3]->E[4,6]

tag9: A[2,3]->D[4,5]

tag10: A[2,3]->D[5,6]

In a tree illustrated in FIG. 2, numbers described on the left of each node denotes a prime number which is given to location indicated by each node, nodes notched inside is for indicating the existence of a path in which a corresponding node is the last node.

Referring again to FIG. 1, the trace record by each tag includes time information when a product has stayed in each location, in addition to the movement path of the product. When requiring the time information, the trace record may be encoded by the region numbering scheme in operation S40.

For this, a time tree structure preferentially is constructed by removing a duplicated node from the trace record.

FIG. 3 is a time tree structure of a trace record according to an embodiment of the present invention. In a time tree structure illustrated in FIG. 3, each node includes time information in each location, i.e., information of start time and end time, and it recognizes a node in which time information as well as location information is identical as a duplicated node, as opposed to the tree of FIG. 2.

In the time tree illustrated in FIG. 3, a pair of number described on the upper portion of each node denotes two numbers (start, end) by the region numbering. The two numbers are continuously allocated through depth-first search from a root of the time tree. The start denotes a number when firstly visiting a corresponding node, and the end denotes a number when finally visiting the corresponding node.

When a node A is an ancestor node of a node B, the two numbers by the region numbering have the attribute of ‘A.start<B.start’ and ‘B.end<A.end’. The time information can efficiently be searched by using the attribute.

Referring again to FIG. 1, the movement path and the time information encoded according to the description are lastly stored in a relational database management system in operation S50.

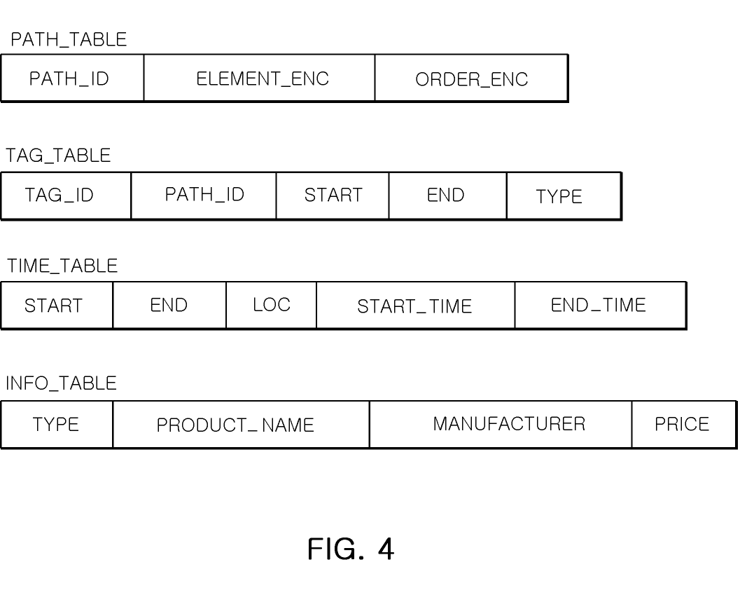

FIG. 4 is a relational schema for storing data in a relational database for supply chain management using RFID according to an embodiment of the present invention. A relational schema by an embodiment of the present invention includes a path table PATH_TABLE, a tag table TAG_TABLE, a time table TIME_TABLE and an information table INFO_TABLE.

The path table is a table for storing a result that is encoded on a path-by-path basis by the path encoding scheme, and includes attributes such as a path ID, the element list encoding number and the order encoding number.

The tag table is a table for storing the movement path information and time information of a corresponding tag on a tag-by-tag basis, and includes attributes such as a tag ID, a path ID, a start, an end, and a product type, wherein the start and the end respectively are a number indicating ID of the time information.

The time table is a table for storing the time information of each location, and includes attributes such as two numbers by the region numbering, a corresponding location, a start time when a product starts to stay in the corresponding location and end time when the product ends to stay the corresponding location.

The information table is a table for storing information of a product. Although attributes such as product type, a product name, a manufacturer, and a price are illustrated in FIG. 4, the attributes of the information table may be constructed differently according to needs.

If the following algorithm is used, the trace record by each tag can be stored in the relational database management system to have the above-described relational schema.

| Input: trace records tr | |
|---|---|
| Begin | |
| 1: for i=0; i<the number of trace records; i++ | |
| 2: | <path_id, store_flag>:=constructTree(tree, tr[i]) |
| 3: | if store_flag == FALSE |

| | |
|---|---|
| 4: | store the path of trace record tr[i] in |

PATH_TABLE using the encoding scheme

| | |
|---|---|
| 5: | store (tag identifier from tr[i], path_id) in |

TEMP_PATH_TABLE

| 6: for i=0; i<the number of trace records; i++ | |
|---|---|
| 7: | constructTimeTree(time_tree, tr[i]) |

8: assign region numbers to nodes in time_tree
9:while traversing nodes in time_tree by the breath-first

search

| | |
|---|---|
| 10: | store nodes of time_tree in TIME_TABLE |
| 11: | store (tag identifier, region numbers for node) in |

TEMP_TIME_TABLE for all tags attached to node

12:after joining TEMP_PATH_TABLE and

TEMP_TIME_TABLE on TAG_ID, fill TAG_TABLE

end

If the trace record is given as the input of the algorithm, a tree is constructed from the trace record using the constructTree (Tree tree, TraceRecord tr) function (line 2). In the constructTree(Tree tree, TraceRecord tr) function, if the path of the trace record tr does not exist in the tree tree, a new path is inserted in the tree tree, a path ID of the new path is returned, and the store_flag is set as False. On the other hand, if the path of the trace record tr exists in the tree tree, a path ID of the path is returned, and the store_flag is set as True.

If the store_flag is False (line 3), the path of the trace record tr is stored by the path encoding scheme (line 4). Subsequently, a tag ID and a path ID are stored in the temporary path table TEMP_PATH_TABLE (line 5), the temporary path table is used to construct a tag table later.

The time tree is constructed from the trace record using the constructTimeTree (TimeTree time_tree, TraceRecord tr) function (line 7). In the constructTimeTree(TimeTree time_tree, TraceRecord tr) function, if the path of the trace record tr does not exist in the tree tree, a new path is inserted in the tree tree. Subsequently, the region encoding number is allocated to each node in the time tree time-tree by the breath-first search (line 8).

Each node in the time tree time_tree is stored in the time table (line 10). Moreover, the tag ID and the region encoding number of a corresponding node are stored in the temporary time table TEMP_TIME_TABLE (line 11).

Finally, the temporary path table and the temporary time table are joined and the tag table is stored (line 12).

The following Tables 1 to 3 respectively represent a path table, a tag table, and a time table, which are constructed by receiving the trace record according to the embodiment of the present invention and using the algorithm.

TABLE 1

| | Element list | Order encoding |
|---|---|---|
| Path ID | encoding number | number |
| 1 | 30 | 23 |
| 2 | 42 | 17 |
| 3 | 110 | 13 |
| 4 | 22 | 13 |
| 5 | 14 | 9 |

TABLE 2

| Tag ID | Path ID | Start | End | Type |
|---|---|---|---|---|
| tag1 | 1 | 3 | 4 | |
| tag2 | 1 | 3 | 4 | |
| Tag3 | 1 | 3 | 4 | |
| Tag4 | 2 | 5 | 6 | |
| Tag5 | 2 | 9 | 10 | |
| Tag6 | 3 | 13 | 14 | |
| Tag7 | 3 | 13 | 14 | |
| Tag8 | 4 | 12 | 15 | |
| Tag9 | 5 | 16 | 17 | |
| Tag10 | 5 | 18 | 19 | |

TABLE 3

| Start | End | Location | Start time | End time |
|---|---|---|---|---|
| 1 | 20 | A | 2 | 3 |
| 2 | 7 | B | 5 | 7 |
| 8 | 11 | B | 7 | 8 |
| 12 | 15 | E | 4 | 6 |
| 16 | 17 | D | 4 | 5 |
| 18 | 19 | D | 5 | 6 |
| 3 | 4 | C | 8 | 9 |
| 5 | 6 | D | 13 | 16 |
| 9 | 10 | D | 14 | 18 |
| 13 | 14 | C | 7 | 8 |

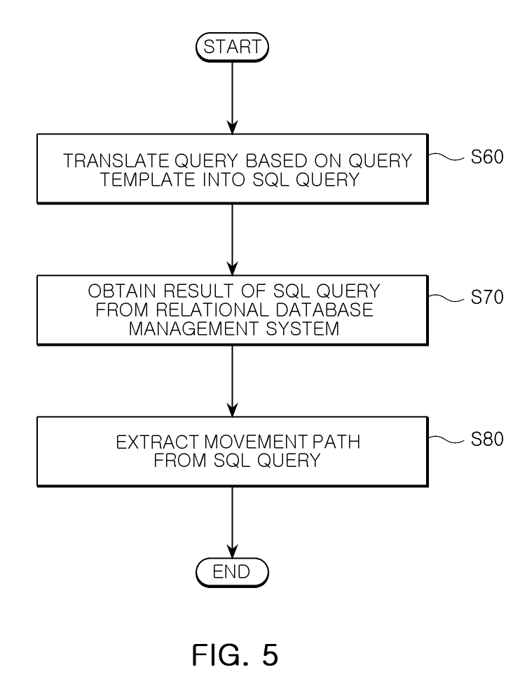

FIG. 5 is a flowchart illustrating a process of processing queries about data stored by embodiments of the present invention.

First, the relational database management system translates a query input from a user into an executable SQL query in operation S60. At this point, the query input from the user is based on a query template defined as follows. In the case where such a query template is used, a query for analyzing the movement path of a product can be performed and processed formally.

[1] Tracking Query= <TagID = id>
[2] Path Oriented Retrieval Query = <PathCondition,

InfoCondition>

[3] Path Oriented Aggregate Query = <AggregateFunction,

PathCondition, InfoCondition>

PathCondition −> (Step)*
Step−> /Loc[TimeCondition] | //Loc[TimeCondition]
AggregateFunction−>count( ) | sum(TimeSelection) |

avg(TimeSelection) | max(TimeSelection) | min(TimeSelection)

TimeSelection −> Loc.StartTime | Loc.EndTime |

Loc.EndTime Loc.StartTime

At this point, the query template is largely classified into and defined as a tracking query, a path oriented retrieval query and a path oriented aggregate query.

The tracking query is for obtaining the movement path information of any tag, and receives the tag ID as an input.

The path oriented retrieval query is for obtaining the information of a tag satisfying any path condition, and receives a path condition PathCondition and an information condition InfoCondition as an input. At this point, the path condition is a form in which each step Step is arranged, i.e., (Step)*, and the each step may be expressed as /Loc[TimeCondition] or //Loc [TimeCondition]. Moreover, the information condition is a search condition of the information table, and may selectively be included according to needs.

The path oriented aggregate query is for obtaining the aggregate information of a tag satisfying any path condition, and receives an aggregate function AggregateFunction as well as the path condition and the information condition as an input. At this point, the aggregate function may be anyone of functions for calculating a computation count( ), a sum sum(TimeSelection), an average avg(TimeSelection), a maximum value max(TimeSelection) and a minimum value min(TimeSelection). Herein, time selection TimeSelection may be any one of the start time of a corresponding location Loc.StartTime, the end time of the corresponding location Loc.EndTime and the stay time of the corresponding location Loc.EndTime-Loc.StartTime.

A query based on the defined query template is translated into a SQL query, examples of which will be described in detail below.

First, in the case of the tracking query, when a tag ID for obtaining a movement path is my tag_id, the tracking query may be translated into the following SQL query.

SELECT P.ELEMENT_ENC, P.ORDER_ENC
FROM PATH_TABLE P, TAG_TABLE T
WHERE T.TAG_ID = my_tag_id AND
T.PATH_ID = P.PATH_ID

Meanwhile, in case of the path oriented query, the path condition is important. For example, when intending to search the movement path including location L₁, L₂, . . . Lₖ, a tuple satisfying a condition ‘ELEMENT_ENC mod (L₁*L₂* . . . *Lₖ)=0’ must be searched in the path table. Moreover, in the path condition, a condition ‘ELEMENT_ENC mod Prime(Lₐ)<ELEMENT_ENC mod Prime (L_{b})’ must be added and searched when adjacent two nodes Lₐ and L_{b} have ancestor/descendant relationships, and a condition ‘ELEMENT_ENC mod Prime(Lₐ)+1=ELEMENT_ENC mod Prime (L_{b})’ must be added and searched when the adjacent two nodes Lₐ and L_{b} have parent/child relationships.

For example, a SQL query about the path oriented retrieval query <//A//B/C> is as follows. pA, pB and pC denote Prime(A), Prime(B), and Prime(C), respectively.

SELECT T.TAG_ID
FROM PATH_TABLE P, TAG_TABLE T
WHERE MOD(P. ELEMENT_ENC, pA*pB*pC) = 0
AND MOD(P.ORDER_ENC, pA) < MOD(P.ORDER_ENC, pB)
AND MOD(P.ORDER_ENC, pB) + 1 = MOD(P.ORDER_ENC, pC)
AND P.PATH_ID = T.PATH_ID

Moreover, a SQL query about the path oriented retrieval query <//A//B [EndTime-StartTime<10]/C> is as follows.

SELECT T.TAG_ID
FROM PATH_TABLE P, TAG_TABLE T, TIME_TABLE S
WHERE MOD(P. ELEMENT_ENC, pA*pB*pC) = 0
AND MOD(P.ORDER_ENC, pA) < MOD(P.ORDER_ENC, pB)
AND MOD(P.ORDER_ENC, pB) + 1 = MOD(P.ORDER_ENC, pC)
AND P.PATH_ID = T.PATH_ID AND S.LOC = ‘B’
AND S.START <= T.START AND T.END <= S.END
AND (S.END_TIME − S.START_TIME) < 10

Furthermore, a SQL query about the path oriented aggregate query <AVG(B.StartTime), //A//B/C> is as follows.

SELECT AVG(S.START_TIME)
FROM PATH_TABLE P, TAG_TABLE T, TIME_TABLE S
WHERE MOD(P.ELEMENT_ENC, pA*pB*pC) = 0
AND MOD(P.ORDER_ENC, pA) < MOD(P.ORDER_ENC, pB)
AND MOD(P.ORDER_ENC, pB) + 1 = MOD(P.ORDER_ENC, pC)
AND P.PATH_ID = T.PATH_ID AND S.LOC = ‘B’
AND S.START <= T.START AND T.END <= S.END

In this way, a query based on the query template is translated into a SQL query, and the translated query is provided to the relational database management system.

A result of the SQL query is obtained from the relational database management system in operation S70. Information desired by a user, for example, the movement path of any product is extracted from the obtained result in operation S80, and the extracted information is provided to the user.

Specifically, in the case of the tracking query, when the element list encoding number and the order encoding number are obtained from the relational database management system, the element list encoding number is factorized in a prime factor and the order of each location is calculated through the order encoding number, and thus a movement path can be obtained by arranging the each location.

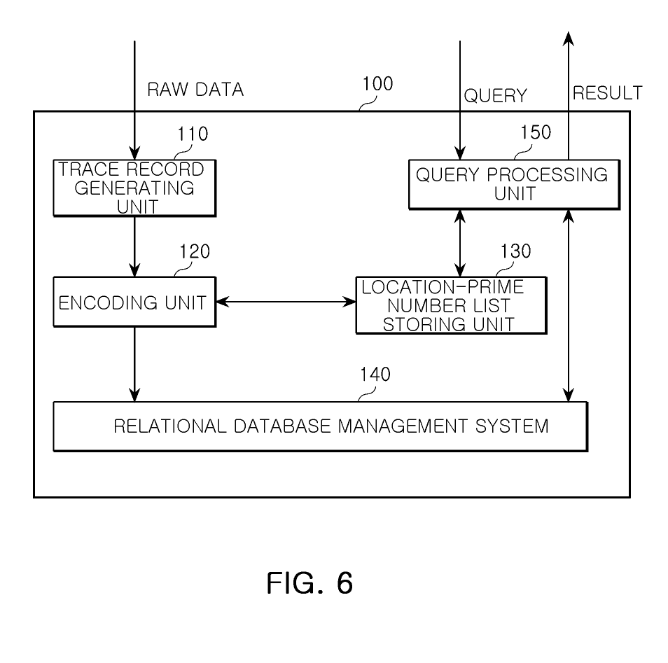

FIG. 6 is a block diagram of a supply chain data management system using RFID according to an embodiment of the present invention. A supply chain data management system 100 stores RFID data generated in a supply chain management system using RFID (not shown) in a relational database management system 140 according to the above-described data storage method, and processes queries about the stored data according to the above-described query processing method to thereby provide a result of the query to a user.

The supply chain data management system 100 includes a trace record generating unit 110, an encoding unit 120, a location-prime number list storing unit 130, the relational database management system 140, and a query processing unit 150.

The trace record generating unit 110 receives raw data generated in the supply chain management system using RFID as an input and translates them into a trace record by each tag according to the above-described processes, and provides the trace record by each tag to the encoding unit 120.

The encoding unit 120 encodes the trace record by each tag by the path encoding scheme and the region numbering scheme, and encodes the each trace record in the element list encoding number, the order encoding number and two numbers (start and end) by the region numbering.

The location-prime number list storing unit 130 stores the list of product location and prime numbers corresponding to the product location, and provides prime number information corresponding to each location of a product to the encoding unit 120 or the query processing unit 150 when the encoding unit 120 applies the path encoding scheme or the query processing unit 150 extracts a movement path from a result of the SQL query.

The relational database management system 140 stores the trace record encoded by the encoding unit 120 in a form of a table having the relational schema, i.e., a path table, a tag table, a time table, and an information table. Moreover, the relational database management system 140 receives and performs the SQL query from the query processing unit 150, and provides the result to the query processing unit 150.

The query processing unit 150 receives the query based on the query template from the user and translates the received query into the SQL query according to the query processing process, and provides the translated SQL query to the relational database management system 140. Moreover, the query processing unit 150 obtains a result of the SQL query from the relational database management system 140, and extracts information desired by the user, for example, the movement path of any product to thereby provide the extracted information to the user.

Embodiments of the present invention can effectively store a massive amount of RFID data generated in the management of the supply chain using the RFID, and obtain easily and quickly the information of the movement path of any product. Moreover, according to embodiments of the present invention, since the RFID data are stored in a relational database management system which is most widely used at present, the establishment of the system is easy and stable.

While the present invention has been shown and described in connection with the exemplary embodiments, it will be apparent to those skilled in the art that modifications and variations can be made without departing from the spirit and scope of the invention as defined by the appended claims.

Accordingly, the spirit and scope of the invention must be determined not by the description and the accompanying drawings but by the appended claims.

What is claimed is:

1. A method for storing data for supply chain management using RFID, the method comprising:
translating raw data generated in a supply chain management system using RFID into a trace record by each tag;
encoding the trace record by a path encoding scheme; and
storing the encoded trace record in a relational database management system.

2. The method of claim 1, wherein in the translating of the trace record, the raw data is translated into a stay record by each tag, and the trace record by each tag is constructed from the stay record.

3. The method of claim 1, wherein the encoding of the trace record is performed encoding the trace record in an element list encoding number and an order encoding number.

4. The method of claim 3, wherein the element list encoding number is a multiplication of unique prime numbers given to each location included in the trace record.

5. The method of claim 3, wherein the order encoding number is a value of X satisfying the k number of equations X mod Prime(L₁)=1, X mod Prime(L₂)=2 through X mod Prime(Lₖ)=k simultaneously when the k number of locations included in the trace record are respectively expressed as L₁ to Lₖ according to the order of a path and Prime(Lₖ) indicates unique prime number given to the location Lₖ.

6. The method of claim 1, wherein the method further comprises encoding the trace record by a region numbering scheme.

7. The method of claim 6, wherein the storing of the encoded trace record is performed storing the trace record encoded by the region numbering scheme in the relational database management system in addition.

8. The method of claim 1, wherein the storing of the encoded trace record is performed storing the encoded trace record in the relational database management system according to a pre-defined relational schema.

9. A method for processing a query about stored data for supply chain management using RFID, the method comprising:
translating a query input from a user into a SQL query to provide the translated query to a relational database management system;
obtaining a result of the SQL query from the relational database management system; and
extracting information of the query input from the user from the obtained result.

10. The method of claim 9, wherein the query input from the user is based on a pre-defined query template.

11. The method of claim 10, wherein the query template comprises a tracking query for obtaining a movement information of any tag, a path oriented retrieval query for obtaining information of a tag satisfying any path condition and a path oriented aggregate query for obtaining an aggregate information of a tag satisfying any path condition.

12. A system for managing data for a supply chain using RFID, the system comprising:
a trace record generating unit configured to receive raw data generated in a supply chain management system using RFID as an input, translate the received raw data into a trace record by each tag, and provide the translated trace record to an encoding unit;
an encoding unit configured to encode the trace record by each tag by a path encoding scheme; and
a relational database management system configured to store the encoded trace record according to a pre-defined relational schema.

13. The system of claim 12, wherein the system further comprises a query processing unit configured to translate a query input from a user into a SQL query to provide the translated SQL query to the relational database management system,
wherein the relational database management system receives and performs the SQL query from the query processing unit, and provides a result of the SQL query to the query processing unit.

14. The system of claim 13, wherein the query processing unit obtains the result of the SQL query from the relational database management system to extract information of the query input from the user from the obtained result.

15. The system of claim 12, wherein the encoding unit encodes the trace record by each tag by a region numbering scheme, and the relational database management system stores the encoded trace record.

16. The system of claim 12, wherein the encoding unit encodes the trace record by each tag in an element list encoding number and an order encoding number.

17. The system of claim 16, wherein the element list encoding number is a multiplication of unique prime numbers given to each location included in the trace record.

18. The system of claim 16, wherein the order encoding number is a value of X satisfying the k number of equations X mod Prime(L₁)=1, X mod Prime(L₂)=2 through X mod Prime(Lₖ)=k simultaneously when the k number of locations included in the trace record are respectively expressed as L₁ to Lₖ according to the order of a path and Prime(Lₖ) indicates unique prime number given to the location Lₖ.

19. The system of claim 15, wherein the encoding unit encodes the trace record by each tag in two numbers by the encoding of a region.

20. The system of claim 12, wherein the system further comprises a location-prime number list storing unit configured to store a list of each location included in the trace record and unique prime number given to the each location.
